(19) United States
(12) Patent Application Publication
(10) Pub. No.: US 2006/0204777 A1
(43) Pub. Date: Sep. 14, 2006

(54) Process for making adhesive bonded sintered plates

(75) Inventors: David Landa, Pensacola, FL (US); Barry Gindoff, Pensacola, FL (US); Bob Hawkins, Pace, FL (US); Raymond Engel, Pensacola, FL (US)

Correspondence Address: Stephen E. Feldman, P.C., Suite 701, 12 East 41st Street, New York, NY, 11017, US

(73) Assignee: Alto Products Corp.

(21) Appl. No.: 11/357,249

(22) Filed: Feb. 17, 2006

Related U.S. Application Data
(63) Continuation-in-part of application No. 09/849,467, filed on May 4, 2001, now abandoned.

(51) Int. Cl. B32B 15/08; F16D 13/00

(52) U.S. Cl. 428/626; 192/70.11

(57) ABSTRACT

The present invention is directed to a method of manufacturing of sintered bonded adhesive plates. The present invention comprises the steps of clearing the metal cores, applying thermosetting adhesives, such as phenolic or epoxy adhesives, to the core layer, then applying sintered layers on top of the adhesive layers and bonding said layers at a temperature in the range of 375-475 F, pressure in the range of 25-1000 psi and bonding such structure for at least 30 seconds. The metal core may be fabricated from metals whose melting point is at least 122° F., such as aluminum. The present invention presents a relatively inexpensive way of manufacturing sintered bonded adhesive plates.

### CROSS-REFERENCE TO RELATED APPLICATIONS

This application is a continuation-in-part of co-pending U.S. application Ser. No. 09/849,467 filed May 4, 2001, hereby incorporated by reference.

### FIELD OF THE INVENTION

The present invention relates transmissions of a land motor vehicle. In particular, the present invention relates to a field of friction clutch plates. More specifically, the present invention relates to a method of making adhesive bonded sintered friction plates using an intermetallic compound such as brass or bronze. Furthermore, the present invention provides a less expensive and more efficient method of bonding materials whose melting point is greater than 1220° F., such as aluminum.

### BACKGROUND OF THE INVENTION

There are several known methods for the making of adhesive bonded sintered plates. However, the conventional methods lack the purpose that the present invention so readily provides. Furthermore, the prior art does not achieve the same results as the present invention does. The following is a discussion of such prior art and the reasons for the lack of complacency with the parameters that the present invention has.

U.S. Pat. No. 4,778,548 to Fox et al. teaches a bonding woven carbon fabric friction materials. This particular prior art discloses a porous, woven carbon fabric friction material that is bonded to a solid substrate, such as a conical transmission synchronizer, with a high temperature thermosetting adhesive, such as synthetic rubber-phenolic resin base adhesive. Prior to applying the adhesive, a thin layer of one surface of the friction material is removed such as by contacting the surface with a band-type sander, to break through the pyrolytic carbon coating on the substantial portion of the carbon fibers. The adhesive is applied to the abraded surface of the friction material and/or roughened surface on the solid substrate, the friction material is clamped to the solid substrate and thus-assembled parts are heated to at least substantially cure the adhesive. Improved bonds between the adhesive and friction material are produced and a tendency for the adhesive to “bleed through” the pores of the friction material and migrate to the friction surface during curing us significantly reduced. The present invention comprises a method of making adhesive bonded sintered metal plates. The process comprises the steps of cleaning metal cores, roughening the surface, where the adhesive would be applied, so that the surface would accept a thermosetting phenolic or epoxy adhesive. Then, placing sintered metal lining on one or both sides of the adhesive coated metal core and bonding the sintered linings under pressure (in the range of 25-1000 psi) and at a temperature (in the range 375-475 F). It is important that the material is bonded for at least 30 seconds. This particular method has an advantage over the previous prior art because it can be used for bonding of sintered parts with metals having melting temperatures greater than 1220 F, such as aluminum. The prior art in question does not allow for such bonding at specified ranges of temperature, time and pressure.

U.S. Pat. No. 5,199,540 to Fitzpatrick-Ellis et al. discloses a friction facing material and carrier assembly. This particular piece of prior art is designed to be used for a clutch driven plate. The assembly comprises two arrays, wherein a first and second arrays are secured, using an adhesive material bonds, to an axis of the clutch driven plate. The adhesive bond that secures the second array comprises an elastomeric material that provides a resilient cushioning relative to the carrier for the second array of friction material. The adhesive bond that secures the first array is axially thinner than the adhesive bond that secures the second array. The present invention is a method for making adhesive bonded sintered metal plates. The method comprises the steps of cleaning the metal cores and roughening the surface to which the thermosetting pheolic or epoxy adhesive would be applied; placing the sintered metal on one or both sides of the adhesive coated metal core and then bonding at a pressure range of 25-1000 psi at a temperature of 375-475 F for a period of at least 30 seconds.

U.S. Pat. No. 5,281,481 to Hayward teaches a method of manufacturing a composite friction element wherein a powdered solventless thermosetting adhesive is applied to a metal substrate and the product made from it. The metal substrate and thermosetting adhesive material are heated to allow the powdered solventless adhesive material to flow but not crosslink. A friction material is applied under the heat and pressure to the adhesive such that the adhesive material crosslinks and a composite element is formed. Furthermore, the adhesive material comprises a resin that contains at least one of the following: 0-70 weight percent range of bisphenol A epoxy resin, unmodified, 0-70 weight percent range of bisphenol A epoxy resin, modified with novolak epoxy, or 0-95 weight percent range of multifunctional epoxy O-cresol novolak resin, and 5-10 weight percent range of bisphenol A epoxy resin with a flow modifier comprising an acrylic acid butyl ester. The present invention is a method of bonding sintered plates using an adhesive. The present invention includes several steps including cleaning the metal core in preparation for application and then later on roughening the application surface so that it would be able to accept a thermosetting phenolic or epoxy adhesive. The present invention bonds the plates at a temperature of 375 F to 475 F at a pressure range of 25-1000 psi for a duration of at least 30 seconds. The present invention allows for bonding of sintered plates, where the metal core may be an aluminum, whose melting point is at 1220° F.

The discussed prior art presents a formidable database of information. However, this prior art does not attempt to solve the problems that the present invention is designed to answer. The present invention is a unique variation of a power anchor band that allows driving of a land motor vehicle under extreme operating conditions such as on rough surfaces or under racing conditions. Due to the specific qualities of the intermetallic compound that is used to manufacture the power band.

It should be clear to one skilled in the art, that the above discussed prior art is used for the purposes of illustration and should not be construed as limiting in any way, except for the prior art elements claimed in the above patents.

### SUMMARY OF THE INVENTION

The present invention discloses a friction clutch plate for a transmission of a land motor vehicle comprising a metal core, an adhesive layer and a first sintered metal lining. The metal core has a first thickness with a top surface and a bottom surface. The adhesive layer has a second thickness and covers the entire top surface of said metal core. The first sintered metal lining has a third thickness and is formed from an intermetallic compound.

The first sintered metal lining covers the entire adhesive layer and is attached to the metal core via the top adhesive layer. This first sintered layer is used for a first specific function, whereby the intermetallic compound allows the first sintered lining to operate under extreme operating temperatures.

The friction clutch plate also may comprise a bottom adhesive layer and a second sintered metal lining. The bottom adhesive layer also covers the entire bottom surface of the metal core and has a substantially equal thickness to that of the top adhesive layer.

The second sintered metal lining is also substantially equal to the thickness of the first sintered metal lining. The second sintered metal lining is attached to the core via the bottom adhesive layer. The second sintered layer may be used for a second specific function.

The first sintered metal lining and second sintered metal lining also may have different compositions. With each compositions allowing the first sintered metal lining and the second sintered metal lining to perform different first and second specific functions, both of which may be under extreme operating conditions.

### BRIEF DESCRIPTION OF THE DRAWINGS

The following description of preferred embodiment of the present invention will be better understood when read in conjunction with the appended drawings. It should be understood, however, that the invention is not limited to the precise arrangements shown in which:

FIG. 1 presents a schematic illustration of the present invention's method steps.

FIG. 2 presents plain view of an outcome after steps of the method in the present invention are applied.

### DESCRIPTION OF THE PREFERRED EMBODIMENT

In the following description, references to the drawings, certain terms are used for conciseness, clarity and comprehension. It is assumed by one skilled in the art that there are to be no unnecessary limitations implied from the references, besides the limitations imposed by the prior art, because such terms and references are used for descriptive purposes only and intended to be broadly construed. Furthermore, the description and the drawings are for illustrative purposes only and not to be construed as limited to the exact details shown, depicted, represented, or described.

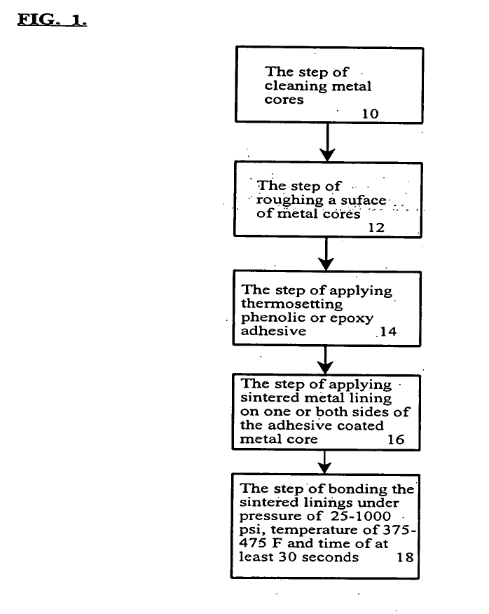

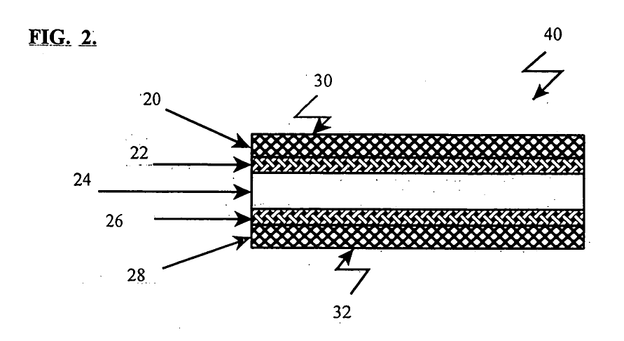

Referring to FIG. 1, the present invention's process is shown. The box labeled 10 indicates that before the process begins to produce the end result depicted in FIG. 2 the metal core 24 should be cleaned on any irregularities, such as corrosions, abrasions or accumulating dusts and other elements that may adversely affect the proper binding of adhesives to the metal core 24. After the metal core 24 is cleaned, if it is necessary the surface of the metal core 24 may be roughened as indicated in the box labeled 12, as shown in FIG. 2. The roughening of the metal core 24 is performed so that the metal core 24 is better able to accept the adhesive 22 and 26, as shown in FIG. 2. When the thermosetting phenolic or epoxy adhesive 22 and/or 26 are applied to the metal core 24 under pressure and temperature, it is vital to the sintered plate 40 that all elements are well bound, otherwise the functionality and lifetime of the sintered plate 40 is greatly reduced. The roughening of step 12 assures such functionality and a longer lifespan of the sintered plate 40.

Referring to FIG. 1, the next step shown in box 14 is applying thermosetting phenolic or epoxy adhesive 22 and/or 26 to the metal core 24, as shown in FIG. 2. The thermosetting phenolic or epoxy adhesive 22 and/or 26 is applied so to prepare the sintered plate 40 and the metal core 24 for the receiving of the sintered metal linings 20 and/or 28, respective of thermosetting phenolic or epoxy adhesive 22 and/or 26. Furthermore, referring to FIG. 1, boxes 16 and 18 describe the final steps of the present invention's method that it results in the sintered metal plate 40 depicted in FIG. 2. Sintered metal lining 20 and/or 28 is respectively applied on top of adhesive layers 22 and/or 26. (A sintered metal lining is, normally, a mixture of steel powders which are axially compacted in a pressing tool. The metal lining obtains its final strength, microstructure and hardness during a heat treatment in a protective atmosphere.)

In the preferred embodiment of the invention, the sintered metal lining 20 comprises an intermetallic compound such as a brass or bronze compound. For example, the sintered metal lining can be a mixture of brass and bronze powders along with other materials that are pressed and subsequently sintered in a protective atmosphere.

This allows the sinitered brass lining 20 to operate at much higher temperatures than ordinary sintered materials because the brass and/or bronze compounds form a special type of chemical compound, called an intermetallic compound. Intermetallic compounds do not separate by mere heating or cooling of the compound. Due this feature, the chemical compound has many advantages when used in devices such as a motor vehicle transmission or brake system that uses friction between objects to operate.

Normal operating friction causes a friction device to operate in controlled heat environments. However, under extreme driving conditions, such as racing or off-road use, the friction materials normally used for this type of environment begin to break down in extreme heat. But when a friction device utilizes brass and bronze under these extreme operating conditions, the brass and/or bronze sintered lining does not break down in the extreme heat and thereby provides increased stability and longevity for the friction device.

In the preferred embodiment of the present invention, a unique variation of a power anchor band that has intermetallic compound allows driving of a land motor vehicle on rough surfaces or under racing conditions. This is due to the specific qualities of the material that is used in manufacturing of the power band.

For background, to make a brass compound, Zinc (Zn) and Copper (Cu) are dissolved in one another to form a metallic solution. They, however, do not form a compound in the normal sense that we use the term “compound” meaning a definite molecular composition. That is, most metal alloys can be separated by purely physical processes, like heating and cooling the alloy (including melting). A chemical compound such as brass cannot be separated so easily because they do not have a fixed composition and thereby form an intermetallic compound.

Intermetallic compounds are formed by two metals that have great differences in their electronegativities and chemical properties. In many of these compounds there is an integral ratio between the sum of the number of valence electrons and the number of atoms. An intermetallic compound is a distinct material from any of the metals that comprise it and often having a completely new crystal structure.

This is opposed to alloys that correspond to a combination of two or more metals. Several types of alloys depend on the nature of the interaction of the two or more metals in the alloys. Many combinations of metals form liquid solutions when fused at high temperatures. Once they are cooled reverting to the solid state they may form a polyphase system, or they may remain in solution and are said to be a solid solution. The metals likely to form solid-solution alloys are those most similar to each other in electronegativity, atomic radii, and chemical properties. The structure of a solid-solution alloy is between the two extremes of order and disorder. In the molten state a high degree of disorder prevails. Upon solidification the random arrangement may be preserved or different degrees of order can appear as result of atoms finding more stable positions in the lattice structure. In turn, these alloys begin to break down at much lower temperatures than intermetallic compounds.

Referring to FIG. 1, box 18, the above-described application takes places under certain conditions to ensure proper binding of all layers, as shown in FIG. 2. In one embodiment, the conditions that the binding of the sintered plates takes place are a pressure of 25 to 1000 psi that is applied to the plates. Such scale of pressure ensures proper binding of the components of the sintered plate 40. Furthermore, in another embodiment, the process described in FIG. 1 may take place at a temperature in the range of 375 F to 475 F. Such temperature ensures that the different kinds of metals may be used for the sintered portion(s) 20 and/or 28, as shown in FIG. 2. Moreover, in yet another embodiment, the process of bonding the sintered plates 40 takes place for at least 30 seconds. Such a time interval is necessary for proper adhesion of phenolic or epoxy adhesives 22 and/or 24, as shown in FIG. 2, together with sintered plates layers 20 and/or 28 and the metal core layer 24.

After steps 10 through 18 as shown in FIG. 1 have taken place, the sintered bonded plate 40 is a final result, as shown in FIG. 2. The sintered plate 40 is shown to have a top face 30 and a bottom face 32. In one embodiment, the sintered plate 40 may have both the top face 30 and the bottom face 32. In another embodiment, the sintered plate 40 may have just the top face 30. Depending on the purpose of use of the sintered plate 40, the plate may have both the top and the bottom faces or just a single top face. The sintered plate 40, as shown in FIG. 2, has both the top and the bottom faces 30 and 32, respectively.

Referring to FIG. 2, the sintered plate 40 has a top sintered layer 20 and a bottom sintered layer 28, wherein the top sintered layer 20 is located at the top of the top face 30 and the bottom sintered layer 28 is located at the bottom face 32. The sintered plate 40 has a metal core layer 24. The metal core layer 24 may be of variable thickness, depending on the application of the plate. Moreover, the metal core layer 24 may be fabricated from different metallic elements of variable strength, sturdiness and other characteristics. The metal core layer 24 and the sintered layers 20 and 28 are attached through a process defined in FIG. 1, and by means of top adhesive layer 22 attaching top layer 20 and the metal core 24 and by means of bottom adhesive layer 26 attaching bottom layer 28 and the metal core 24.

The layers 22 and 26 may be fabricated from a phenolic or epoxy adhesives or others that are well known in the art. The sintered layers 20 and 28 may be fabricated from a metal that is capable of performing a specific function that a user has in mind. However, it is vital to keep in mind that the process described in FIG. 1 and above is designed for metals that have a melting temperature, such as aluminum, of at least 450 F. The melting point of the metals used in the structure allows a greater flexibility in terms of variety of materials that the components of the sintered plate 40 may be chosen from. Furthermore, the present invention has another advantage that is closely tied with the subject matter sought to be patented, it is the cost of the making such plate. Because of the particular methods and materials used in the invention, the cost of manufacturing the present invention is significantly lower than of those prior art invention currently available.

In the foregoing description of the invention, reference to the drawings, certain terms, have been used for clarity, conciseness and comprehension. However, no unnecessary limitations are to be implied from or because of the terms used, beyond the requirements of the prior art, because such terms are used for descriptive purposes and are intended to be broadly construed. Furthermore, the description and illustration of the invention are by way of example, and the scope of the invention is not limited to the exact details shown, represented, or described.

While the present invention has been described with reference to specific embodiments, it is understood that the invention is not limited but rather includes any and all changes and modifications thereto which would be apparent to those skilled in the art and which come within the spirit and scope of the appended claims.

What is claimed:

1. A friction clutch plate for a transmission of a land motor vehicle comprising:
a metal core having a first thickness, the metal core having a top surface, a bottom surface;
an adhesive layer having a second thickness, the adhesive layer covering the entire top surface of said metal core; and
a first sintered metal lining having a third thickness, the first sintered metal lining formed from an intermetallic compound, the first sintered metal lining covering the entire adhesive layer, the first sintered metal lining being attached to the metal core via the top adhesive layer, and the first sintered layer being used for a first specific function,
whereby the intermetallic compound allows the first sintered lining to operate at extreme operating temperatures.

2. The friction clutch plate of claim 1 further comprising:
a bottom adhesive layer covering the entire bottom surface of the metal core, the bottom adhesive layer being substantially equal to the thickness of the top adhesive layer;
a second sintered metal lining being substantially equal to the thickness of the first sintered metal lining, said second sintered metal lining being attached to the core via the bottom adhesive layer, and said second sintered layer being used for a second specific function.

3. The friction clutch plate of claim 2 whereby the first sintered metal lining and second sintered metal lining have different compositions, said different compositions allowing the first sintered metal lining and the second sintered metal lining to perform different first and second specific functions.
